(19) United States
(12) Patent Application Publication
(10) Pub. No.: US 2014/0182280 A1
(43) Pub. Date: Jul. 3, 2014

(54) PARALLEL CYCLE FOR TIDAL RANGE POWER GENERATION

(71) Applicant: Ramez Atiya, Salt Lake City, UT (US)

(72) Inventor: Ramez Atiya, Salt Lake City, UT (US)

(21) Appl. No.: 14/238,986

(22) PCT Filed: May 31, 2012
(86) PCT No.: PCT/US12/00263

§ 371 Date: Feb. 14, 2014

Related U.S. Application Data
(60) Provisional application No. 61/524,222, filed on Aug. 16, 2011.

(51) Int. Cl. F03B 13/26

(52) U.S. Cl. CPC F03B 13/268
USPC 60/327

(57) ABSTRACT

A parallel cycle process of extracting energy from the rise and fall of the ocean tides utilizes a marine enclosure capable of supporting a differential head, equipment capable of using a differential fluid head to generate electricity and equipment capable of pumping against a differential head to generate power from the rise and fall of ocean tides in a manner that preserves and maintains sensitive intertidal zones.

### TECHNICAL FIELD

This invention relates to the generation of power from the ocean tides, and specifically relates to processes for preserving ecologically sensitive intertidal zones during the process of power generation using tidal energy.

### BACKGROUND

Tidal power plants exploit the difference in water levels, caused by the rise and fall of the tides (i.e., ebb and flow, respectively), between the sea and a basin defining a body of water. The difference in water levels, or the “differential head,” is exploited to drive water through turbine-generators associated with a tidal range power plant to produce electric power. A turbine-generator is defined as a hydropower turbine connected to an electric generator. A tidal range power plant operates much like a river hydroelectric power plant (HEP). However, an HEP requires a basin in which stored water is kept at a permanently higher level to generate power, whereas a tidal power plant exploits the rise and fall of tides to drive water through turbines to generate power.

All tidal range power plants share certain common features in terms of structure and operation. A tidal range power plant forms an enclosure that separates a basin from the sea. Tidal range power plants include a powerhouse, which houses turbines-generators, sluices which provide openings designed to pass large flows of water, and dykes, inactive elements that connect the other elements to each other and to the shore to complete the enclosure (FIG. 2.a). The powerhouse is equipped with gates which can be opened and closed to control the flow of water through the turbine-generators, and the sluices are equipped with sluice gates which can be opened and closed to control the flow of water.

Various types of turbines and generators are used in a typical tidal range power plant, including horizontal bulb turbine-generators (bulb turbine-generators) which are particularly convenient for tidal range power applications. Bulb turbine-generators include both the turbine and the generator in a single unit. Bulb turbine-generators are available which can generate power with flow of water from the sea to the basin and vice-versa from basin to sea. Such turbine-generators are called two way or double effect turbine-generators.

Tidal range power plants include a control system for the operation of the powerhouse gates, the sluice gates, and the turbines-generators. Modem control systems are fully computerized. The control system may be housed in the powerhouse or can be housed in a separate building located away from the plant.

Although structurally similar, the way in which tidal power plants are operated can differ in significant and in vitally important ways. The method of operating a tidal power plant is referred to as its operating cycle. Tidal range power plants exploit the differential head across the enclosure to drive water through turbine-generators to produce electric power. The way in which that differential head is exploited differentiates the various cycles. Conventional tidal range operating cycles, cycles which have been developed to date, fall into two broad categories: One way generation, also referred to as a single effect cycles, and two way generation referred to as double effect cycles. One way cycles generate with the flow of water in one direction only, while two way cycles generate power. While a river hydroelectric plant operates with flow in only one direction, the rise and fall of the tides drive water back and forth through the turbines of tidal power plants. The two way flow makes it possible to generate power with flow in either direction.

These two conventionally known methods of power generation differ in their processes, and also differ in their effects, including their environmental impact, the amount of energy produced and the period of time over which a unit of energy is produced. Of greatest concern, however, is the fact that conventional operating cycles proposed to date have major negative impacts on the environment. Conventional operating cycles result in the loss of intertidal zone. The intertidal zone is that area that is alternately submerged and exposed by the rising and the falling of the tides. The intertidal zone is bounded by the shoreline at low tide and by the shoreline at high tide.

Intertidal zones are among the most biologically productive and important areas in the world. The incoming tide brings in and deposits nutrients. The nutrients support a rich and diverse assemblage of plants and animals. Intertidal zones support large populations of resident and migratory birds who feed on the plants and the invertebrates who inhabit the intertidal flats. Conventional cycles result in the partial loss of intertidal zones. The loss of intertidal habitat has been a major obstacle to the deployment of tidal range power, a technology with the capacity to produce 15% to 40% of the world's electric power consumption with no greenhouse gas emissions.

In addition to the environmental impact, the loss of intertidal habitat (zone) has negative commercial consequences. Intertidal zones are rich in shellfish, a commercially significant resource, and the loss of intertidal zone can result in the loss of a commercially valuable harvest. Consequently, the loss of intertidal zone caused by conventional operating cycles has blocked progress on otherwise important tidal range power projects.

Conventional operating cycles have additional negative environmental impacts. Most conventional operating cycles result in sedimentation within the enclosed basin, which negatively impacts the dynamic ecological balance of the basin.

Conventional operating cycles alter the natural ebb and flow of the tides. Macrotidal environments, environments with large tides are among the most productive marine environments. The ecological integrity of these environments depends critically on the unimpeded ebb and flow of the tides. Conventional operating cycles alter the tidal regime in ways that have a severe negative on the ecological integrity of macrotidal environments.

In addition to their negative environmental impact, the most frequently proposed conventional cycles produce electricity in large pulses of brief duration. These are difficult to absorb by the grid. In addition, large pulses require large, and therefore, costly transmission capacity. The short duration of power generation and the cost of transmitting the energy produced when conventional operating cycles are employed present additional obstacles to the deployment of tidal range power.

Heretofore, no method of tidal energy power generation has been able to address the negative effects that are inherent in these methods. Specifically, no method of tidal energy power generation has addressed the loss of intertidal zone. As a result, tidal energy power processes have not been as widely and successfully exploited, and, in fact, many anticipated projects have been abandoned due to the negative impacts that would ensue.

### DISCLOSURE OF INVENTION

The methods of the present disclosure employ tidal range power to generate power while reducing or eliminating the negative environmental impacts of conventional operating cycles. In particular, the methods of the present disclosure provide environmentally low-impact operating cycles that preserve the intertidal zones as a primary benefit. This is accomplished by alternately submerging and exposing the intertidal zone in the enclosed basin, submerging and exposing the same area as would such as would occur naturally in the absence of a tidal power plant. In addition, the methods of the present disclosure provide environmentally low-impact operating cycles that prevent deleterious sedimentation in the basin.

The methods of the present disclosure have additional advantages pertaining to the quality of the electricity produced. The disclosed methods produce electricity over a longer period of time than conventional cycles and the electricity is, therefore, more easily absorbed by the grid and requires less transmission capacity than electricity produced using conventional operating cycles.

The methods of the disclosure provide significant advantages over conventional methods of exploiting tidal energy, including the following:
The methods preserve the natural boundaries of the intertidal zones.
The rise and fall of water within the basin more closely mimics or parallels the natural tidal cycle when the tidal power plant is operated using the present methods, thereby preserving the ecology of the intertidal zone by mimicking the natural ebb and flood of the tides on which nutrient balance depends.
The methods reduce or eliminate sedimentation in the basin by maintaining the ebb and flow of the tides in the basin, thereby preserving the energy content of the water.
The methods extract more energy than conventional methods for a given basin area and tidal range.
The methods produce energy over a longer period of time than conventional methods during each 6.3 hour tidal cycle.
Because the disclosed methods produce each unit of energy over a longer period of time rather than in a concentrated pulse as is achieved by conventional methods, less transmission capacity is required.
Because the disclosed methods produce each unit of energy over a longer period of time rather than in a concentrated pulse, the grid can absorb that energy more easily.
The disclosed methods can re-time power delivery more easily, thereby providing better load following.

The methods of the present disclosure extract energy from the rise and fall of the ocean tides in a controlled manner that preserves the intertidal zone of a basin by selectively transferring water from the sea body to the basin, through a tidal range power plant, at rates that maintain the boundaries of the intertidal zones.

More specifically, the methods of the present disclosure utilize a marine enclosure capable of supporting a differential head, equipment capable of using a differential fluid head to generate electricity and equipment capable of pumping against a differential head.

For tides up to a pre-determined maximum, the disclosed methods include the following four phases given in relative order: (1) A flood generation phase that harnesses the differential head created by the rising (flood) tide across the enclosure to generate power; (2) A pumping phase, following flood generation phase, that further raises the level of the basin by transferring water from the sea to the basin; (3) An ebb generation phase that harnesses the differential head created by the falling (ebb) tide across the enclosure to generate power; and (4) A pumping phase, following the ebb generation phase, that further lowers the level of the basin by transferring water from the basin to the sea.

For tides above a pre-determined maximum, the rising tide overtops the enclosure. The economics of installing the additional capacity required to utilize very high tides determines the maximum tide for which overtopping is designed. On each tide, ranging from the minimum to the maximum, the methods of the present disclosure flood and expose those areas that would have been flooded and exposed by the natural tides, i.e., had the enclosure been absent.

The methods of the disclosure provide for the generation of power from tidal energy that preserves the intertidal zone by establishing a barrier between a sea body and a basin to enclose the basin from the sea body; providing means for selectively transferring water between the sea body and the basin responsive to a rise and fall in water levels caused by the ebbing and flowing tides; determining an intertidal zone in the basin, the intertidal zone being defined between an upper boundary and a lower boundary of the shoreline of the basin between which the natural rising and falling of water levels in the basin, due to the ebb and flow of the sea tides, exists at any given tidal event; transferring water between the sea body and the basin to maintain a water level in the basin that resides within the determined intertidal zone; and generating power through the transfer of water between the sea body and the basin.

### BRIEF DESCRIPTION OF THE DRAWINGS

The methods of the present disclosure are further to be understood in conjunction with the following illustrations:

FIG. 1.a illustrates a first embodiment of the methods of the present disclosure for an average tide at a location with tidal range 5.5 m a graphical over a 25 hour period;

FIG. 1.b illustrates a second embodiment of the methods of the present disclosure for an average tide at a location with tidal range 5.5 m a graphical over a 25 hour period;

FIG. 2.a-FIG. 2.j illustrate schematically the flow of water during ten consecutive phases of water transfer in accordance with the methods of the disclosure, where FIG. 2.a shows the resting phase which precedes the initiation of a flood generation phase;

FIG. 2.b illustrates schematically the initiation of the flood generation phase of the methods;

FIG. 2.c illustrates schematically the flood generation and sluicing phase of the methods;

FIG. 2.d illustrates schematically the pumping and sluicing phase following the flood generation phase of FIG. 2.b;

FIG. 2.e illustrates schematically the pumping phase that follows the flood generation phase;

FIG. 2.f illustrates schematically a resting phase following flood generation;

FIG. 2.g illustrates schematically the initiation of the ebb generation phase;

FIG. 2.h illustrates schematically the ebb generation and sluicing phase;

FIG. 2.i illustrates schematically the initiation of a pumping and sluicing phase following the ebb generation and sluicing phase;

FIG. 2.j illustrates schematically the pumping phase following the pumping and sluicing phase; and

FIG. 3 shows the Ebb and Flood Generating cycles with method of the present disclosure, for comparison.

### REFERENCE NUMERALS USED IN THE DRAWINGS

(10) Tidal Range Power Plant
(20) Basin
(22) Barrier
(30) Dykes
(40) Powerhouse
(42) Powerhouse Gates
(50) Sluices
(52) Sluice Gates
(60) Intertidal Zone
(62) Shoreline at low tide
(64) Shoreline at mid-tide
(66) Shoreline at high tide
(70) Solid arrow indicating direction of flow from the sea into the basin
(72) Blank arrow indicating direction of pumping from the sea into the basin
(74) Solid arrow indicating direction of flow from the basin into the sea
(76) Blank arrow indicating direction of pumping from the basin into the sea

### MODES FOR CARRYING OUT THE INVENTION

To aid in the understanding of the methods of the present disclosure, and the advantages that the methods provide over known tidal power generation methods, the following description of conventional tidal power generation processes is provided for comparative purposes.

### One Way (Single Effect) Cycles

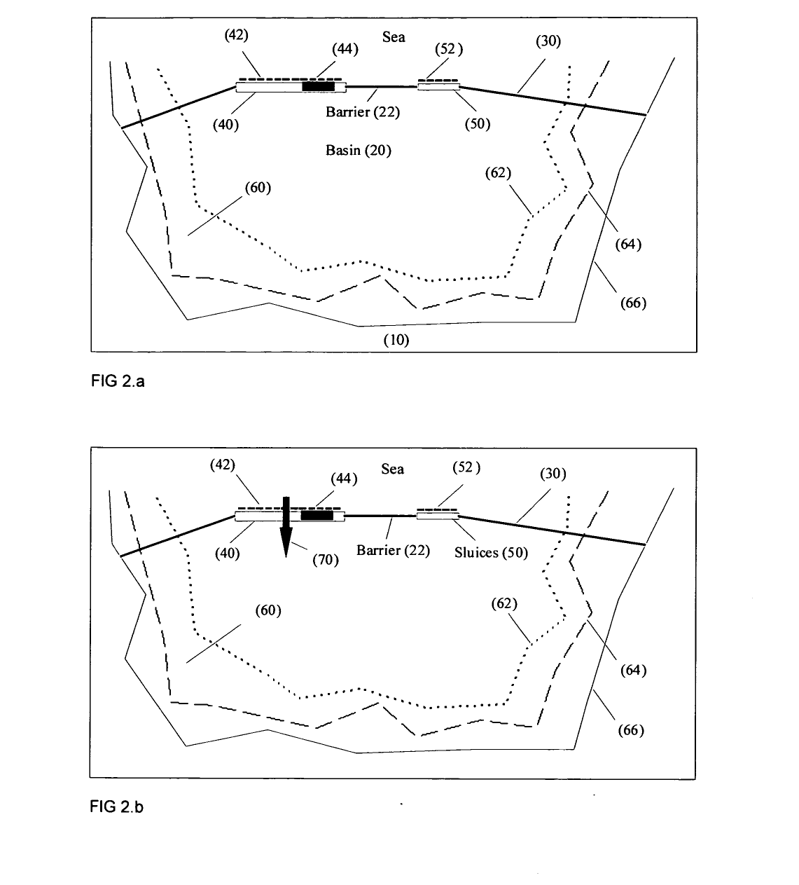

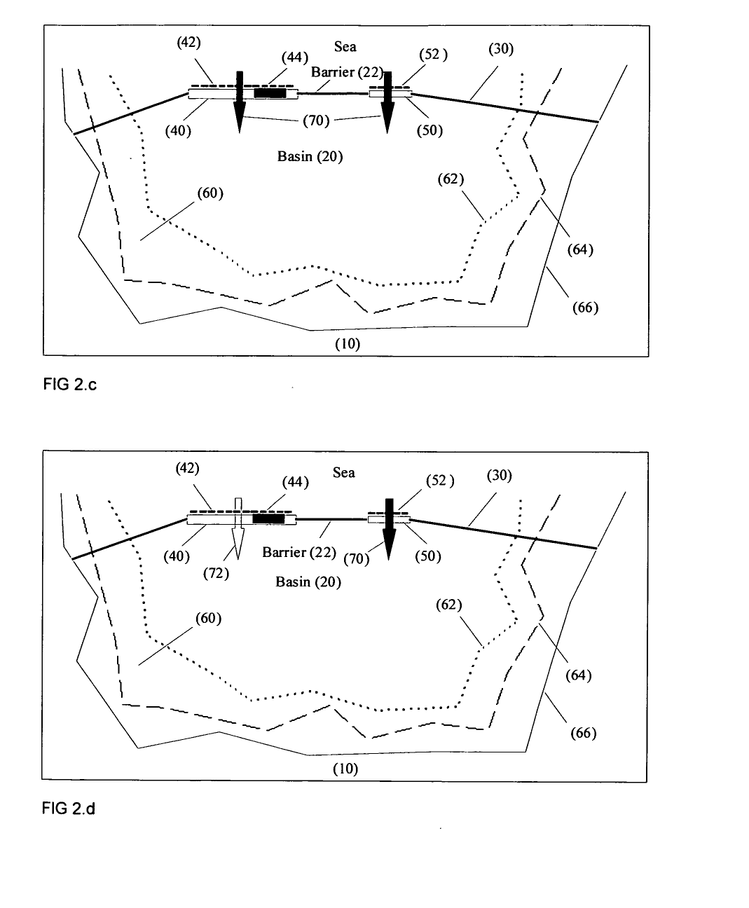

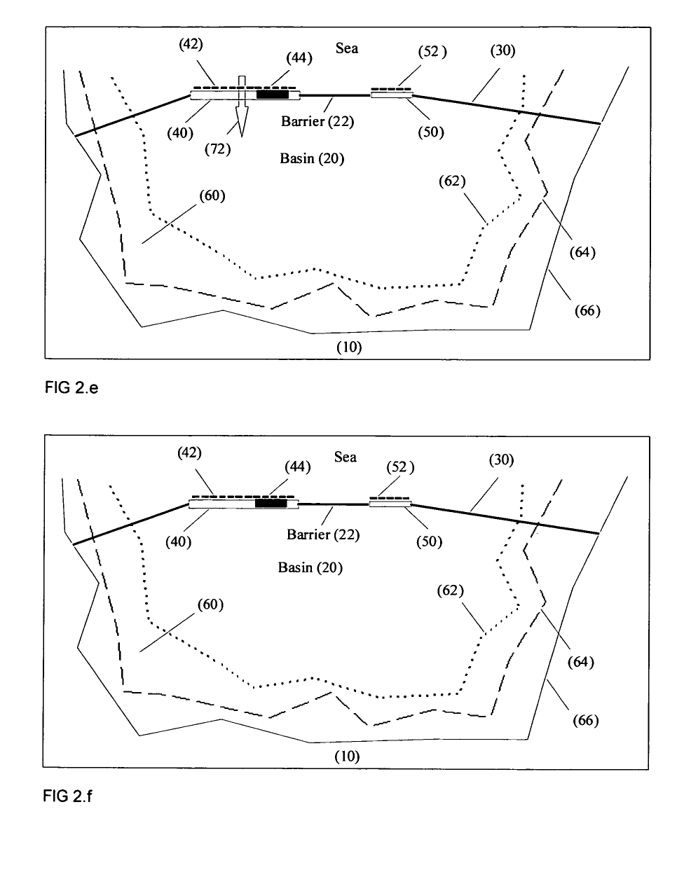

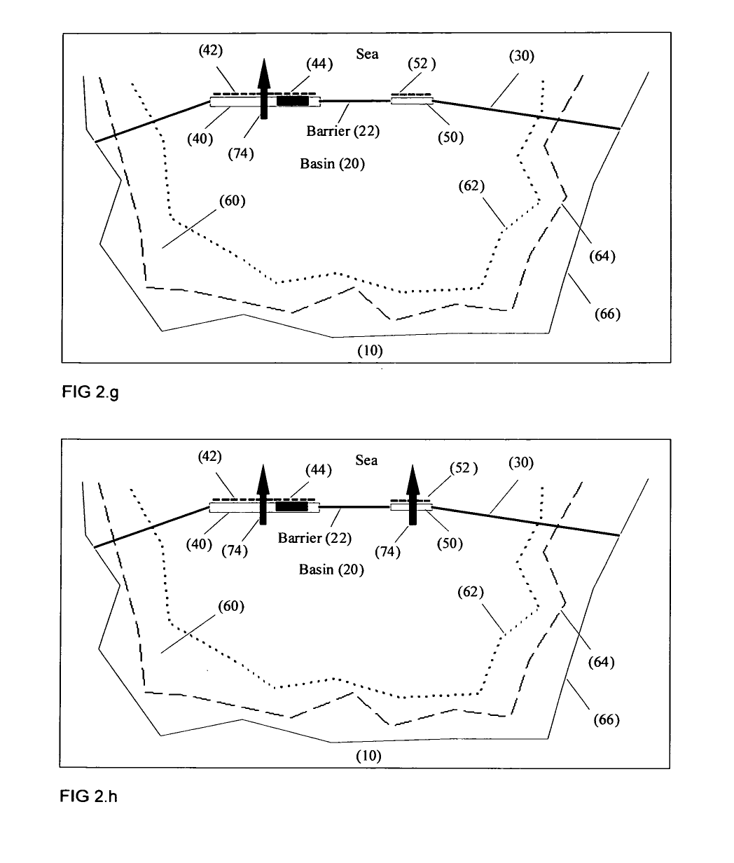

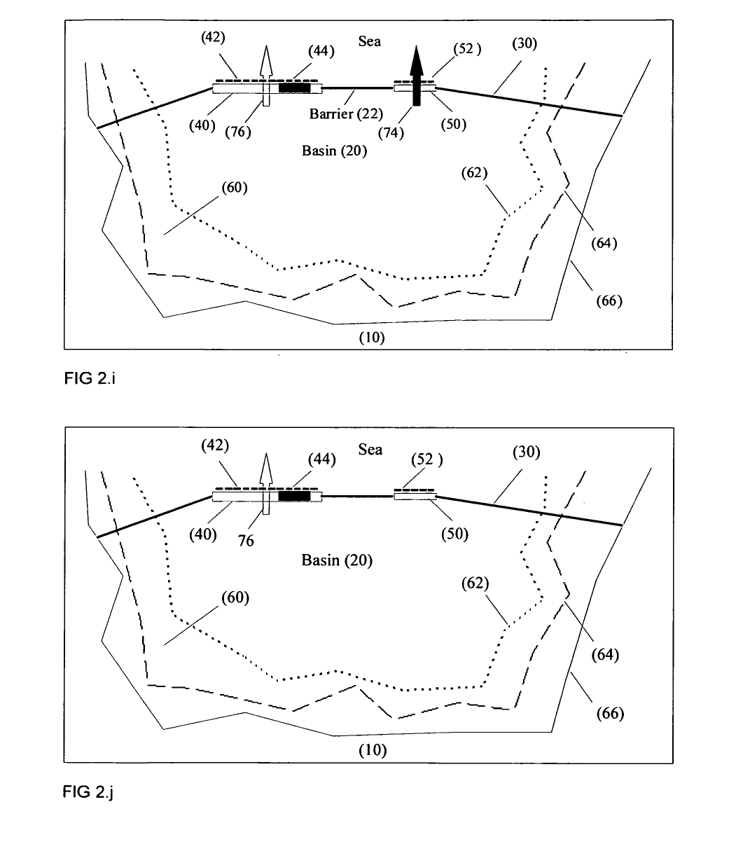

One way cycles employ turbines which are operable upon water flowing in one direction. There are two distinct one way cycles: ebb generation and flood generation. A conventional tidal power plant can be used in carrying out both cycles. For the sake of easy reference, the power plant structures that are illustrated in FIG. 2a are referred to in the following descriptions of one way and two way power generation cycles to facilitate an understanding of these cycles.

(A) The Ebb Generation Cycle

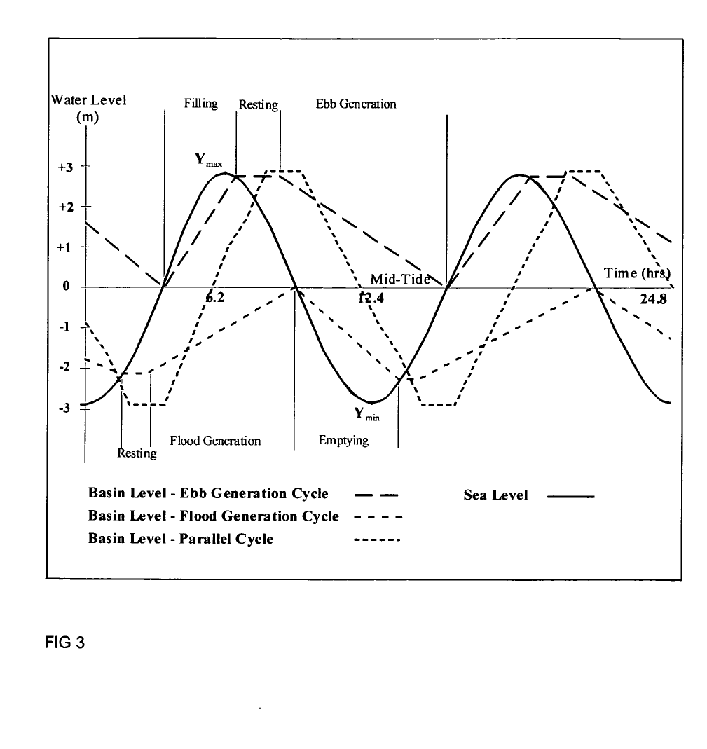

There are three phases for an ebb generation cycle: a filling phase, a resting phase and an ebb generation phase. FIG. 3 graphically demonstrates water levels during each of the phases. The various water levels in the basin during the phases of the ebb generation cycle are represented by the dashed line, as indicated in the legend of FIG. 3. The phases of ebb generation are denoted at the top of FIG. 3.

In the filling phase, the sluice gates (52) are opened (see FIG. 2a). As the sea level rises with the flooding tide, water fills the basin through the open sluice gates (52). Close to high tide, the sea and basin water levels are at the same level, the sluice gates are closed. The basin is at its highest level. This ends the filling phase.

The filling phase is followed by the resting phase. During the resting phase, the basin water level remains at a constant high level while the water level in the water level sea falls with the ebbing tide. A differential head is thereby created between the sea and the basin with the water level being higher in the basin than in the sea.

The ebb generation phase begins when a sufficient head is created between the sea and the basin. The powerhouse gates (42) are opened and water flows from the basin through the turbine-generators in the powerhouse and into the sea, the water level of which is now lower than the water level of the basin. The ebb generation phase is the power generation phase. Water continues to flow through the turbine generators producing power, until the level of the sea and basin are equal. This occurs when the sea level is at mid-tide, which is represented in FIG. 3 at “0” This is shown in FIG. 3 as the point of intersection between the sea level line (solid) and the broken line representing the basin level for the ebb generation cycle. (Baker A. C. Tidal Power, Peter Peregrinus Ltd. on behalf of the Institution of Electrical Engineers, 1991 p. 21, & Clark, Robert H. Elements of Tidal-Electric Engineering, IEEE Press on Power Engineering, Wiley Inter-Science, John Wiley & Sons Inc., 2007 p. 110).

The result of the ebb generation cycle in conventional tidal energy methods, as described thus far, is the permanent loss of fully half of the intertidal zone. This can be seen by noting in FIG. 3 that the basin level, during the ebb generation cycle, never falls below the mid-tide level. In the natural rise and fall of the tides, (i.e., in the absence of the tidal power plant), the water level would fall to a level represented by the lowest point on the solid curve representing the sea water level, the point labeled Yₘᵢₙ. The entire area normally exposed (in the absence of the barrier) between low tide, Yₘᵢₙ, and mid-tide becomes permanently submerged when the ebb generation process is employed. This represents the permanent loss of half of the intertidal zone. This is the area between the shoreline at mid-tide (64) and the shoreline at low tide (62), as illustrated in FIG. 2a. A full half of the intertidal zone becomes permanently submerged and lost. The ecology of the intertidal zone is permanently altered and damaged. Essential habitat for resident and migratory birds who feed on exposed intertidal zone at low tide is lost. Shell fish harvesting takes place on the exposed tidal flats during low tide. The area over which harvesting can take place is reduced by 50%. Commercially valuable area which is harvested for shellfish is lost.

The ebb generation cycle as described thus far is the most commonly proposed operating cycle for proposed tidal range power plants. It was the cycle proposed for the Severn Barrage in the 1981, the 1989, and the 2010 proposals. Located in the Severn Estuary between England and Wales, the Barrage would have produced about 5% to 7% or the UK's total electricity consumption. A major reason for the failure of all three projects was the substantially negative environmental consequences of the ebb generation cycle. The Strategic Environmental Assessment of Proposals for Tidal Power Development in the Severn Estuary prepared for the Department of Energy and Climate Change of the UK (2010) reported a projected loss of 8,073 to 15,894 hectares of intertidal habitat. This massive loss of intertidal zone was a major reason cited by government for abandoning the project in spite of its important contribution to greenhouse gas reductions. The lost intertidal zone was valued at between £ 1.049 billion and £ 2.066 billion (DECC, 2010, Vol. 2, p. A31)). The Report further added that a price tag cannot be easily assigned to such ecologically important habitat.

Of additional importance is the fact that ebb generation eventually causes the enclosed basin to fill with sediment in the absence of dredging. The ebb generation cycle has other drawbacks. The cycle produces power in large pulses of short duration.

(B) The Flood Generation Cycle

An alternative one way or single effect power generating cycle is the flood generation cycle. The flood generation cycle suffers from the same shortcomings as noted with respect to the ebb generation cycle. FIG. 3 shows the flood generation cycle, where the water level in the basin for the flood generation cycle is represented by the dashed line denoted in the legend. The three phases of flood generation, the resting phase, the flood generation phase and the emptying phase are marked in FIG. 3 below the water level lines. The flood generation phase ends when the level of water in the basin and the water level in the sea are equal. This is the point of intersection of the dashed line representing the basin water level and solid line representing the sea water level. Note that the level water in the basin never rises above the mid-tide line (“0” water level on FIG. 3). During natural tide flows (i.e., in the absence of the tidal power plant), the level of the water would rise to the apex of the solid curve marked Yₘₐₓ, the high tide level. The result is that intertidal zone above mid-tide, the entire area between the shoreline high tide (66) and the shoreline mid-tide line (64), as depicted in FIG. 2.a, becomes permanently exposed and is turned into dry land (i.e., littoral zone).

The flood generation cycle suffers from the same drawbacks associated with the production of power in large pulses. As with ebb generation, large pulses of power generation require more transmission capacity and are more difficult to absorb by the grid. In addition, for a bowl shaped basin, the surface area of the water and, therefore, the volume available for power generation is smaller than for ebb generation. A plant operated on a flood generation cycle produces less energy than the same plant in the same basin operated on an ebb generation cycle or one operated on the methods of the present disclosure, as described hereinafter. The flood generation cycle, like the ebb generation cycle, eventually causes the basin to fill with sediment in the absence of dredging.

The flood generation cycle is the operating cycle which is used for the 520 MW Sihwa Lake Tidal Power Plant in Korea. Sihwa Lake commenced operation in 2011. The flood generation cycle at Sihwa Lake was appropriate because of very special circumstances. Sihwa Lake was initially a land reclamation project. Sihwa Bay was cut off from the sea by an embankment. The intent was for sediment to fill the basin, creating new agricultural land. However, industrial development and the lack of flushing caused the “lake” to become highly polluted. The deployment of a tidal power plant and in particular, the use of flood generation was intended to flush

the basin. There was no intertidal zone left to protect at Sihwa and environmental conditions were already highly compromised.

### Two Way (Double Effect) Cycles

(A) Two Way Generating Cycle Without Pumping.

Two way or double effect operating cycles are the second major group of generating cycles. Two way cycles generate power on both the ebb and on the flood cycles of the tides. Like one-way generation, available two way generating cycles result in the loss of intertidal zone. Graph I, above, taken from Tidal Power from the Severn Estuary, Vol II, p. 148, shows the water and basin levels projected by the Severn Barrage Committee for the proposed 1979 Severn Barrage.

An examination of Graph I shows that the level of the basin does not rise to the high tide level or fall to the low tide level. These are the apex and the nadir of the line marked “Tide level” in the figure above, and are further labeled “Low tide” and “High tide” on the horizontal axis. As a result large sections of the intertidal zone, which are normally submerged at high tide, become permanently exposed, and large areas of the intertidal zone that are normally exposed at low tide become permanently submerged. The overall result is the loss of intertidal zone in both the ebb and the flood generation phases, as labeled in Graph I. Two way cycles that do not employ pumping lead to similar loss of intertidal zone. All cause lands that are normally exposed at low tide to become permanently submerged and lands that are normally submerged at high tide to become permanently exposed and converted into dry land. Two way generation without pumping has the combined disadvantages of both one way cycles previously described.

(B) Two Way (Double Effect) Cycles with Pumping

A variant of two way or double effect power generation employs pumping using turbines that are structured to pump water in two opposing flow directions, thereby being operable to act as a pump and as a turbine. Turbines with two way generating and pumping capability have been installed in the power plant at La Rance in France. An exhaustive summary of operating cycles is found in L. B. Bemshtein Tidal Energy for Electric Power Plants (Translated from the Russian by the Israel Program for Scientific Translations, 1965, published by The U.S. Department of the Interior and the National Science Foundation, Washington D.C., 1965). The important related work of Robert Gibrat is found in in L′Energie des Marees (Presses Universitaire De France, Paris, 1966). An examination of Gibrat's two way generation with pumping leads to a loss of intertidal zone. Areas that are normally submerged at high tide become exposed and areas that are normally exposed at low tide are submerged (Gibrat, p. 81). Gibrat optimizes power generation at the cost of losses of intertidal zone.

Although Gibrat and Bemshtein's work investigated the use of augmenting two way generation by pumping, both their investigations were aimed at maximizing energy output They did not investigate the use of pumping or other measures to preserve the boundaries of the intertidal zone. Gibrat cycles, like two way or double effect power cycles results in the loss of intertidal zone

As discussed, conventional tidal power generation has been developed with the objective of maximizing power generation; and while there has been a recognition that conventional tidal power generation has significant, negative environmental impacts, no solutions or new methodologies have been developed which are directed to reducing or eliminating the negative environmental effects of tidal power generation.

Accordingly, the methods of the present disclosure are specifically directed to preserving the intertidal zone of a basin by controlling the transfer of water from the sea body to a basin in a manner that maintains the water level in the basin between low and high boundaries of the intertidal zone in order to thereby mimic the natural rise and fall of the tides with respect to the intertidal zone. The methods of the present disclosure may, therefore, be referred to herein as a parallel cycle.

It is understood that the tides vary from one day to the next. Graph II, below

Illustrates the tidal variation over a 31 day period at a location where regular, semi-diurnal tides prevail. The vertical axis indicates the water level, and the horizontal axis plots time over 31 days. Examination of Graph II shows that at days 6 and 21 the sea water levels reaches a minimum at high tide. Maxima are reached on days 15 and 27. High tide and low tide are separated by 6.2 hours.

An “individual tidal cycle,” as defined herein, consists of the rise and fall of the tide from one high tide to the following low tide. A “natural individual tidal cycle” as defined herein consists an individual tidal cycle in the basin in the absence of a tidal power plant or any other impediment to the tidal wave. Each individual tidal cycle has an approximate duration of 6.2 hours. As the tide recedes from high to low during each individual tidal cycle, the intertidal zone is exposed. The natural individual cycle intertidal zone is that area which becomes exposed in the course of an individual tidal cycle as the tide recedes from high tide to low tide in the absence of any impediment such as a tidal power plant. Equivalently, the natural individual cycle intertidal zone is that area which becomes exposed as the tide recedes from high tide to low tide in the course of a natural individual tidal cycle. The natural individual cycle intertidal zone is that area bounded by the shoreline at high tide (66) and at low tide (62), as depicted in FIGS. 2a-2j, over the course of a natural individual tidal cycle, in the absence of any impediment such as a tidal power plant. This natural individual cycle intertidal zone is represented as 60 in FIGS. 2a-2j. Two distinguishing definitions are required. The “individual cycle intertidal zone” is defined herein as the area between the upper boundary (66) and the lower boundary (62) of the shoreline of the basin in the course an individual tidal cycle (FIGS. 2a-2j). The “natural individual cycle intertidal zone” is defined herein as the area between the upper boundary and the lower boundary of the shoreline of the basin in the course that individual tidal cycle in the absence of power a power plant or other impediment to the tidal wave. The “natural individual cycle tidal range” is defined as the difference in water level between low tide and high tide for each individual tidal cycle that would have been obtained in the basin had the tidal power plant been absent. Equivalently, the natural individual cycle tidal range is defined as the difference in water level between low tide and high tide for each natural individual tidal cycle.

The natural individual cycle high tide and low tide levels are the highest and lowest level of the sea on an individual cycle. As applied to the basin, the “natural individual cycle high tide and low tide levels” are the levels in the basin for an individual tidal cycle that would be reached in the absence of any enclosure or other impediment to the natural flow of the tidal wave. The individual cycle tidal range for one of the cycles on day 6 in Graph II is about 1.4 m. Graph II also shows that the individual cycle tidal range increases to a local maximum of about 3.5 m on day 15. It then decreases and increases again. The cycle repeats itself approximately once every 29.53 days, or the synodic month.

Lower tides are known as neap tides, and higher tides as spring tides. Because the moon undergoes irregular movements due to perturbations, the individual cycle tidal range exhibits further small variations.

The methods of the present disclosure maintain the intertidal zone by pumping and releasing water from the basin, through a barrier or enclosure that separates the basin from a sea body, to parallel, and thus preserve, the natural individual cycle intertidal zone. As used herein, the word “sea” or “sea body” includes estuaries, inlets, bays or any body of water that is subject to the tides. Further, as used herein, the phrase “tidal event” refers to the unique tides, of which there are, approximately, 705 in a given year, and their unique time of occurrence. The “maximum natural tidal range” is defined as the absolute greatest difference in water level between low tide and high tide for any past individual tidal cycle. The “maximum intertidal zone” is defined as the natural individual cycle intertidal zone for that tidal event with the maximum natural tidal range. The maximum intertidal zone is the largest intertidal zone.

In accordance with the methods, pumping is employed to raise and lower the water level in the basin to coincide with the naturally occurring water levels for each individual tidal cycle. However, a second option raises or lowers water level in the basin beyond their natural values but still within the absolute natural maximum and minimum levels in the basin. The latter of option of additional pumping is included for energy and environmental reasons that will be explained below.

The parallel cycle places an emphasis on the benefits of pumping to achieve preservation of the intertidal zone.

In another aspect of the methods of the present invention, overtopping is employed for extreme high tides. That is, for extreme high tides, the water level of the tides exceeds the highest elevation point, or top, of the enclosure. The enclosure then becomes submerged. Under these circumstances, the tide rises to its natural level without requiring further pumping. The option of overtopping is included in order to ensure that even at extreme high tides, the intertidal zone becomes submerged. The reasons for overtopping are given in greater detail below.

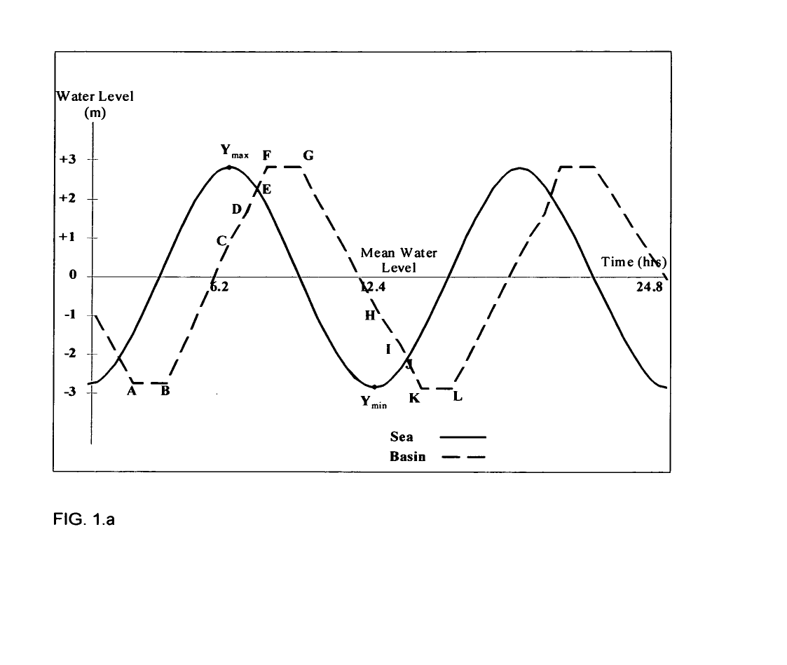

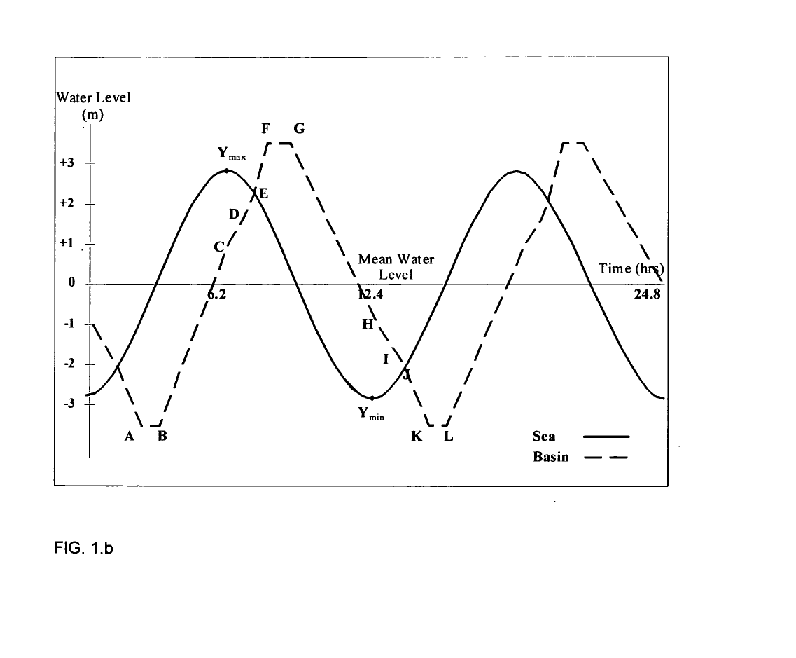

The degree to which the parallel cycle raises the water level in the basin defines various embodiments of the methods of the disclosure. A first embodiment is graphically illustrated in FIG. 1.a, and is further illustrated in FIGS. 2.a-2.j, which depict a tidal range power plant (10) comprised of a barrier (22) separating a basin (20) from the sea. The barrier (22) or enclosure is provided with an arrangement of dykes (30), and at least one powerhouse (40) as part of the barrier. The powerhouse (40) provides housing for turbine- generators (not shown). The turbine-generators are installed to produce power with flow from the sea to the basin and vice-versa from basin to sea. Separate turbine-generators for each direction of flow can be employed. Modem turbine-generators are available which generate power with flow in both directions. These are referred to as two way or double effect units. The powerhouse (40) is also fitted with at least one powerhouse gate (42) which controls the flow of water between the sea and the basin (20), allowing water when the gates are open to pass through the turbine-generators to produce power. The tidal range power plant (10) may also include at least one sluice (50) as part of the barrier (22). The sluice (50) is fitted with at least one sluice gate (52) through which water is transferred between the sea and the basin (20). The sluice (50) may alternatively be constructed as part of the powerhouse (40).

FIG. 1.a provides a graphical representation of a first embodiment of the methods of the disclosure in which the water level in the sea and the water level in the basin (22) are depicted over a 25 hour period at a site where the average tidal range is 5.5 meters. The vertical axis represents the level of the water in meters relative to mean water level set at 0 meters. The horizontal axis represents time expressed in hours. The solid line represents the water level of the sea and the dashed line represents the water level of the basin over a 25 hour period. As FIG. 1.a shows, the rise and fall in the water level in the basin follows or parallels to a high degree the rise and fall of the water level in the sea during the operation of methods of the disclosure. Thus, the methods of the disclosure derive the name “parallel cycle” from the fact that, through the method, the rise and fall of the water level in the basin mimics, or parallels, the rise and fall of the sea water level. The rise and fall of the water level in the basin is timed to follow the rise and fall of the water in the sea, but is shifted to slightly later time.

The parallel cycle of the present disclosure is described in ten phases, the ten phases being depicted in FIGS. 2a-2j. In FIG. 1.a, the start of each of the ten phases is labeled by the letters A through K, corresponding to FIGS. 2a through 2j.

A to B: FIG. 2.a—Resting phase. In this phase, the powerhouse gates (42) and sluice gates (52) are closed. No water passes between the sea and the basin (20). Over the period from A to B (FIG. 1.a), the water level in the sea, represented by the solid line, is rising with the incoming (flooding) tide, while the water level in the basin, represented by the dashed line, remains at a constant level. The differential head between the sea and the basin increases throughout interval A to B. At B there is sufficient head to generate power.

B to C: FIG. 2.b—Flood (rising tide) generation phase. At B, the powerhouse gates (42) open. Water flows from the sea to the basin (20), in the direction of the solid arrow (70), through the turbine-generator(s), thereby generating power. Throughout the interval B to C, the water level in the sea continues to rise as the basin fills, except possibly for a brief period at the end of the interval after the tide level in the sea has reached a maximum and begins to fall. Power generation continues to point C.

C to D: FIG. 2.c—Flood generation & sluicing phase. At C, the sluice gates (42) open. Water flows from the sea to the basin in the direction of the solid arrow (70). Allowing water to pass through the sluice gates (52) increases the net flow and raises the water level in the basin more quickly than if water flowed through the turbine-generators alone.

D to E: FIG. 2.d—Pumping & sluicing phase. At D there is insufficient head to generate power. The turbine-generators are switched to operate as pumps, as depicted by the blank arrow (72), pumping water from the sea into the basin (20) to increase the rate at which the basin fills. Simultaneously, water continues to flow from the sea into the basin through the sluice gates (52). The water level in the basin continues to rise while the water level in the sea falls with the ebbing tide (FIG. 1.a). At E, the water levels in the basin and in the sea become equal.

E to F: FIG. 2.e—Pumping phase. At E, the water level in the sea and the water level in the basin are equal. The sluice gates (52) close. The turbine-generators continue to pump water from the sea and into basin until point F when the water in the basin has been raised to the desired level. For the first embodiment of the method illustrated in FIG. 1.a, the desired level is the naturally occurring high tide level for that individual tidal cycle. At F, the powerhouse gate is closed.

F to G: FIG. 2.f—Resting phase. The powerhouse gates (42) and sluice gates (52) are closed. No water flows between the sea and the basin. During the period F to G, the water level in the basin remains constant. The water level in the sea continues to drop as the tide ebbs. At G, sufficient head has developed to generate power.

G to H: FIG. 2.g—Ebb generation phase. At G, the powerhouse gates (42) open. Water flows from the basin to the sea through turbine/generators as indicated by direction of the solid arrow (74), thereby producing power. Throughout the period G to H, the water level in the basin (20) continues to drop as the basin empties. At the same time, the water level in the sea continues to drop with the ebbing tide, except possibly for a brief period at the end of the interval, G to H, when the tide reaches a minimum or low and begins to rise again.

H to I: FIG. 2.h—Ebb generation & sluicing phase. At H, the sluice gates (52) open allowing water to flow from the basin to the sea in the direction of the solid arrow (74). This brings the water level in the basin down more quickly than if water is allowed to flow through the turbines alone. Power generation continues until point I, when there is insufficient head.

I to J: FIG. 2.i—Pumping & sluicing phase. At I, there is insufficient head to generate power. The turbine-generators are switched to act as pumps, and pumping of water from the basin to the sea begins as indicated by the direction of the blank arrow (76), thereby increasing the rate at which the water level in the basin falls. Water continues to pass from the basin to sea through the sluice gates (52). Simultaneous pumping and flow of water through the sluice gates (52) continues until water levels in the sea and the basin become equal (point J on FIG. 1.a).

J to K FIG. 2.j—pumping phase. At J, the water level in the sea and the water level in the basin are equal. The sluice gates (52) close. The turbine-generators continue in pump mode in the direction of the blank arrow (76), further lowering the level of water in the basin. When the level has been reduced to the desired level at K (FIG. 1.a), the powerhouse gates shut. For embodiment one, by “desired level” is meant the naturally occurring level of the tide for that cycle.

Referring to FIG. 1.a, the phase from K to L represents a resting phase during which all gates are in a closed position and there is no flow of water between the sea and the basin. During this time interval, the water level in the basin stays constant. The water level in the sea begins to rise with the tide until there is sufficient head to start flood generation again.

The method of the first embodiment has the beneficial consequence of preserving the intertidal zone. The intertidal zone (60) (FIG. 2.a) is that region between the shoreline (62) at low tide and the shoreline (66) at high tide (FIG. 2.a). The natural individual cycle intertidal zone is that region between the shoreline at low tide and the shoreline at high tide for that particular individual tidal cycle that would have been obtained in the basin in the absence of the power plant. The intertidal zone becomes submerged at high tide and exposed at low tide. It is this action of the tide that is essential to maintaining the ecology of the intertidal zone. In the presence of the tidal power plant, in accordance with the methods of the disclosure, the natural intertidal zone is submerged and exposed, mimicking the natural action of the tidal wave. The intertidal zone is thereby protected. It is precisely this benefit which is accomplished through pumping at the end of the flood generation phase (points E to F), and at the end of the ebb generation phase (points J to K).

The need to transfer or pump water in order to fully submerge and expose the intertidal zone can be seen by examining FIG. 1.a representing embodiment one. The pumping phase E to F (FIG. 1.a) raises the level in the basin, flooding the natural individual cycle intertidal zone. Without pumping, the basin would only rise to its level at E (FIG. 1.a). In the absence of the power plant, the basin level would rise to the same maximum as the sea (the apex on the solid curve representing water level in the sea marked Yₘₐₓ), a point higher than the basin level at E. Without pumping, land normally submerged at high tide would remain exposed. The effect holds true for all tidal cycles from neap to spring tides. The effect applies to each individual tidal cycle. The net effect is that in the absence of pumping, the intertidal zone that is normally submerged at high tide, would become permanently exposed, turning a portion of the intertidal zone into permanent dry land (littoral). Pumping raises the water level so that the naturally occurring level is always reached for every tidal cycle. An examination of FIG. 1.a shows that there would be loss of intertidal zone at low water as well. The pumping phase J to K (FIG. 2.j) lowers the level of the basin (FIG. 1.a). Without pumping the level of the basin would never drop below its value at J (FIG. 1.a). In the absence of the tidal power plant, the water level in the basin would drop to the minimum attained by the sea (the lowest point along the solid curve marked Yₘᵢₙ) exposing the intertidal zone. Without pumping down, intertidal zone that is normally exposed at low tide would remain permanently submerged. Therefore, without pumping there is loss of intertidal zone at both low tide and high tide. In embodiment one, the Parallel Cycle exposes and submerges the intertidal zone to its natural extremes (Yₘₐₓ and Yₘᵢₙ in FIG. 1.a) for each individual tidal cycle. The natural boundaries of the intertidal zone defined by the highest tides are never exceeded. The Parallel Cycle therefore maintains the natural boundaries of the intertidal zone. By exposing and submerging the natural intertidal zone, the Parallel Cycle protects its ecological structure. Other cycles fail to provide that protection.

The first embodiment maintains the natural individual high tide, Yₘₐₓ, and the natural individual cycle low tide, Yₘᵢₙ (FIG. 1.a). The natural rise and fall of the tides is maintained for each individual tidal cycle. It therefore most closely parallels natural conditions in the basin.

In accordance with a second embodiment, depicted in FIG. 1.b, the water level in the basin is caused to exceed the natural individual tidal cycle high tide, Yₘₐₓ, and the natural individual tidal cycle low tide, Yₘᵢₙ (FIG. 1.a). One reason motivating this embodiment is its ecological advantages under certain circumstances. Neap (low) tides submerge and expose smaller areas of intertidal than spring (high) tides. At some locations with very high tides, this can produce heat stress on the intertidal zone. Vast areas of intertidal zone remain exposed at neap tides. Exposure to the summer sun over extended periods desiccates and stresses the intertidal zone with damaging consequences to its ecology. Exposure during summer neap tides has even been implicated in increased activity of predatory snails. Exceeding the natural individual cycle tidal range can therefore have beneficial environmental effects. Embodiment two therefore provides scope for environmental optimization.

The requirement that each natural individual cycle intertidal zone be submerged and exposed on each individual tidal cycle can be achieved by pumping by installing sufficient pumping capacity (turbine-generators). For extremely high tides, installing the necessary capacity can be very costly. Furthermore, very high tides are relatively infrequent. Therefore, the additional capacity required for their utilization is not economically justifiable. Nevertheless, the protection of the intertidal zone even for high tides is both desirable and achievable. A third embodiment of the parallel cycle employs overtopping in order to expose and submerge the natural individual cycle intertidal zone for very high tides. The dykes (30) are built to a height so that they become overtopped or submerged for those tides which exceed a certain level. The specific tidal range for which overtopping is desirable is determined by the benefits of additional energy generation versus the cost of installing additional capacity. Overtopping provides the required protection of the intertidal zone at an acceptable cost.

The methods of the present disclosure provide the added benefit of reducing or eliminating sedimentation. In embodiment one, the natural ebb and flow of the tides is reproduced. The same quantity of water enters and leaves the basin as it would in the absence of the tidal power plant. The rate of flow is very close or equal to the natural rate of flow in and out of the basin. (Neither of these conditions is met by the other cycles described). The natural energy flow is therefore preserved. The result is that the overall sedimentary regime is closely maintained. Pumping is key. Without pumping the net energy content of the water in the basin would be reduced. The net loss of energy would result in the deposition of sediment. Additional pumping in embodiment two further reduces the rate of sediment deposition.

The methods of the present disclosure provide the added benefit of producing power over a longer period of time. The Parallel Cycle is represented in FIG. 3 alongside the ebb generation cycle and the flood generation cycle. A comparison (FIG. 3) shows that the Parallel Cycle produces power over a longer period of time than the ebb generation cycle. By producing a given unit of energy over a shorter period of time, the ebb generation cycle produces a large pulse of power. Because a large pulse of power must be transmitted, the ebb generation cycle requires more transmission capacity than the Parallel Cycle which produces energy at a lower rate but over a longer period of time. Extending the period over which power is delivered reduces the transmission capacity required. The Parallel Cycle therefore reduces the cost of transmission over conventional methods.

The methods of the present disclosure provide the added benefit of producing power that is more easily absorbed by the grid. It is difficult for the grid to absorb power generated in large pulses or in surges of power. The more nearly continuous power produced by the Parallel Cycle is easier to absorb. The Parallel Cycle has similar advantages over the flood generation cycle shown in FIG. 3.

The methods of the present disclosure provide the added benefit of producing additional energy over other methods. The Parallel Cycle produces more energy than the ebb generation cycle (the most commonly proposed cycle), the flood generation cycle, or two way generation cycles without pumping. This can be shown by direct calculation. A detailed comparison is given by Bemshtein (Bemshtein, Tidal Energy for Electric Power Plants, p. 38). Double effect power generation (two way generation) has a maximum capacity factor of 34%. That is, double effect power generation extracts 34% of the energy contained in the tidal wave. For single effect the capacity factor drops to 22.4%. Bemshtein examines 13 different operating cycles. All are shown to have a lower capacity factors and therefore produce less energy. The addition of pumping further increases net energy output over the 34% capacity of two way generation. It may appear that the use of pumping should result in a net loss of energy since pumping requires energy and since equipment is less than 100% efficient. This is not correct. The reason can be seen by comparing the difference in water levels, the differential head, at which pumping and generating are carried out (FIG. 1a.) Pumping is carried out between E and F, when the differential head is small. Therefore pumping is carried out against a small differential head, requiring less power. Power generation begins at G, when the differential head is much larger, producing more power. The net result is that more energy is generated than consumed. Pumping can produce a net energy gain of as much as 6% over the two way (double effect) cycle. The capacity factor of Parallel Cycle can be as high as 40%. Embodiment two augments pumping further increasing the energy yield.

The methods of the present disclosure provide the added benefit of being able to adjust the time of power delivery. The Parallel Cycle can re-time power delivery more easily. This can be seen by examining FIG. 1.a or 1.b. The point at which the ebb generation phase of the Parallel Cycle begins (marked G) can be moved to an earlier or later time (to the left or to the right). The flexibility allows for better load following. Similar remarks apply to the flood generation phase of the Parallel Cycle (point B). Therefore the Parallel Cycle provides flexibility in the time of delivery of power. The added flexibility makes it simpler to meet fluctuations in demand. The Parallel Cycle therefore has better load following capability.

### Implementation of the Parallel Cycle

The implementation of the methods of the present disclosure is carried out using well understood methods developed for the operation of hydroelectric facilities. The implementation of the Parallel Cycle begins with a determination of the physical characteristics of the site. These are the tidal range, the live water volume in the basin (the volume of water that must pass through the barrier (22) or enclosure), the water level as a function of time in response to the tidal wave, and the bathymetry of the basin. A choice of operating conditions is then made. A starting head and an averaged rate of flow (the discharge) through the turbines are selected. The starting time and flow capacity of the sluices is selected. The physical conditions at the site together with the selected operating condition (including equipment efficiency) determine the requirements and the behavior of the generating system. The behavior of the system includes the power output, the flow rate through the turbine-generators and the sluices, and total energy output The installed capacity (the total power of the installed turbine-generators) is further adjusted to meet pumping requirements dictated by the choice of embodiments, one or two. The system is then optimized to minimize the equipment required and maximize energy output The Parallel Cycle can therefore be implemented using the methods of hydropower generation.

What is claimed is:

1. A method of generating power from tidal energy that preserves intertidal zones, comprising:
establishing a barrier between a sea body and a basin to enclose the basin from the sea body;
providing means for selectively transferring water between the sea body and the basin responsive to a rise and fall in water levels caused by the ebbing and flowing tides;
determining a natural individual cycle intertidal zone in the basin, the natural individual cycle intertidal zone being defined as the area between the upper boundary and the lower boundary of the shoreline of the basin in the course that natural individual tidal cycle;
determining the maximum intertidal zone, the maximum intertidal zone being defined as the natural individual cycle intertidal zone for that tidal event with the maximum natural tidal range;
transferring water between the sea body and the basin wherein for each tidal event the upper boundary of the individual cycle intertidal zone within the basin lies between the upper boundary of the natural individual cycle intertidal zone in the basin and the upper boundary of the maximum intertidal zone in the basin and wherein for each tidal event the lower boundary of the individual cycle intertidal zone within the basin lies between the lower boundary of the natural individual cycle intertidal zone in the basin and the lower boundary of the maximum intertidal zone in the basin.; and
generating power through the transfer of water between the sea body the basin.

2. The method according to claim 1 wherein power is generated by transfer of water from the basin to the sea body.

3. The method according to claim 2 wherein power is generated by transfer of water from the sea body to the basin.

4. The method according to claim 1 wherein the barrier comprises a tidal power plant further comprised of a powerhouse, a powerhouse gate, at least one sluice and sluice gate and at least one turbine-generator.

5. The method according to claim 4 wherein the at least one sluice gate and the at least one turbine are in operative communication with a programmable control system that effects operation of the at least one sluice gate and at least one turbine-generator at selected times to maintain the water level of the basin within the determined intertidal zone during transfer of water between the sea body and the basin.

6. The method according to claim 1 wherein the transfer of water between the sea body and the basin is carried out by pumps associated with the barrier.

7. The method according to claim 6 wherein the pumps are structured to operate alternately between functioning as pumps and as turbine-generators. The method according to claim 1 wherein the height of the barrier is selected to be substantially equivalent to the upper boundary of a selected intertidal zone.
